(19) United States
(12) Patent Application Publication
(10) Pub. No.: US 2011/0292326 A1
(43) Pub. Date: Dec. 1, 2011

(54) REFLECTIVE DISPLAY DEVICE

(76) Inventors: Eiji Satoh, Osaka (JP); Kiyoshi Minoura, Osaka (JP); Yasushi Asaoka, Osaka (JP)

(21) Appl. No.: 12/672,308

(22) PCT Filed: Jul. 24, 2008
(86) PCT No.: PCT/JP08/01976

§ 371 Date: Feb. 5, 2010

(30) Foreign Application Priority Data
Aug. 7, 2007 (JP) 2007-205390

(51) Int. Cl. G02F 1/1335

(52) U.S. Cl. 349/113

(57) ABSTRACT

A reflective display device includes a retroreflective layer 10 with unit structures arranged two-dimensionally on a virtual plane, and conducts a display operation by using light reflected from the retroreflective layer. The device further includes: gate lines 35 arranged on a rear substrate 32; source lines 34 also arranged on the rear substrate 32 to cross the gate lines 35 as viewed from over a front substrate 30; a switching element 33 also arranged on the rear substrate 32 and activated in response to a signal supplied to its associated gate line 35; a pixel electrode 36 electrically connectible to its associated source line 34 via the switching element 33; and a counter electrode 38 arranged to face the pixel electrode 36. Each unit structure of the retroreflective layer 10 has a recess defined by three planes opposed perpendicularly to each other. As viewed from over the front substrate 30, each of the gate and source lines 35, 34 defines an angle of at least 7 degrees with respect to any of the azimuthal directions defined by projecting normals to the three planes of each unit structure onto the virtual plane.

### TECHNICAL FIELD

The present invention relates to a reflective display device with a retroreflective layer.

### BACKGROUND ART

A reflective liquid crystal display device for conducting a display operation by utilizing surrounding light as its light source has been known in the art. Unlike a transmissive liquid crystal display device, the reflective liquid crystal display device needs no backlight, thus saving the power for light source and allowing the user to carry a smaller battery. Also, the space to be left for the backlight in a transmissive device or the weight of the device itself can be saved. For these reasons, the reflective liquid crystal display device is effectively applicable to various types of electronic devices that should be as lightweight and as thin as possible.

A technique of combining a scattering type liquid crystal display mode and a retroreflector is one of known means for improving the display performance of a reflective liquid crystal display device. Such a technique is disclosed in Patent Documents Nos. 1 to 4, for example.

Hereinafter, the operating principle of a display device that adopts such a technique will be described with reference to FIGS. 1(a) and 1(b), which schematically illustrate the black and white display states of the display device.

As shown in FIG. 1(a), if a liquid crystal layer 1 is controlled to exhibit a transmitting state, an incoming light ray 3, which has been emitted from a light source 5 outside of the display device, is transmitted through the liquid crystal layer 1 and then reflected back by a retroreflector 2 toward its light source 5 (as reflected light 4b). Consequently, the light ray 3 that has been emitted from the light source 5 does not reach the eyes of a viewer 6. In such a state, the image reaching the eyes of the viewer 6 from this display device is the image of his or her own eyes. In this manner, the “black” display state is realized.

On the other hand, if the liquid crystal layer 1 is controlled to exhibit a scattering state, the incoming light ray 3 that has been emitted from the light source 5 is scattered by the liquid crystal layer 1 as shown in FIG. 1(b). Specifically, if the liquid crystal layer 1 is a forward scattering liquid crystal layer, most of the incoming light ray 3 is scattered forward by the liquid crystal layer 1 and then reflected back by the retroreflector 2 toward the viewer 6 through the liquid crystal layer 1 in the scattering state (as reflected light 4w). In this case, since the retroreflectivity of the retroreflector 2 is disturbed by the scattering caused by the liquid crystal layer 1, the incoming light ray 3 does not return to its light source. In the meantime, another portion of the incoming light ray 3 is scattered backward by the liquid crystal layer 1 and directed toward the viewer 6 (not shown). In this case, that portion of the light directed toward the viewer 6 reaches his or her eyes, thus realizing a “white” display state. According to this operating principle, not just the backscattering but also forward scattering of the liquid crystal layer 1 can be used effectively. As a result, a brighter “white” display is achieved.

By conducting a display operation based on this operating principle, a monochrome display is realized without using any polarizer. Consequently, a high-brightness reflective liquid crystal display device, of which the optical efficiency is not decreased by the use of polarizers, is realized.

As the retroreflector 2 shown in FIG. 1, a corner cube array that exhibits high retroreflectivity can be used effectively. The “corner cube array” is a two-dimensional arrangement of corner cubes, each defined by three planes that are opposed substantially perpendicularly to each other, on a certain “virtual plane”. The “virtual plane” is typically a plane that is defined parallel to the surface of the display panel of a display device. A light ray that has entered a corner cube is ideally reflected back toward its source by the three planes that form the corner cube. FIGS. 2(a) and 2(b) are respectively a plan view and a perspective view illustrating the configuration of a corner cube array. The corner cube array shown in FIGS. 2(a) and 2(b) is a cubic corner cube array in which a number of corner cubes, each being defined by three square planes that are opposed perpendicularly to each other, are arranged two-dimensionally.

To further increase the contrast ratio on the screen of a reflective display device that uses a corner cube array, Patent Document No. 3 suggests that a corner cube array consisting of corner cubes of a reduced size be used as a retroreflector. A corner cube array consisting of corner cubes of such a reduced size (e.g., with an arrangement pitch of 5 mm or less) will be referred to herein as a “micro corner cube array (MCCA)”. Also, the arrangement pitch of corner cubes in an MCCA is identified herein by Pcc (i.e., the shortest distance between two adjacent peak paints or bottom points) as shown in FIG. 2(a).

A reflective display device with an MCCA may be formed by arranging the MCCA on a display panel so that the MCCA is located on the opposite side (i.e., the non-viewer side) of the display panel. Such an arrangement in which an MCCA is attached to the non-viewer side of a display panel (which will be referred to herein as an “MCCA attached structure”) is disclosed in Patent Document No. 4, for example. As used herein, the “display panel” refers to a panel in which a modulating layer such as a liquid crystal layer and a voltage application means for applying a voltage the modulating layer are sandwiched between two opposed substrates. Of these two opposed substrates, the one substrate to face the viewer will be referred to herein as a “front substrate” and the other substrate not to face the viewer a “rear substrate”. In the MCCA attached structure, the MCCA is arranged in the rear of the rear substrate.

However, it is difficult to form an MCCA, in which corner cubes are arranged at a very small pitch, with high shape accuracy. That is why in a reflective display device that uses an MCCA including such an arrangement of corner cubes at a very small pitch, the black display may sometimes turn slightly lightened black (which is called a “dark-state leakage”) or white and black may sometimes be inverted in a grayscale tone display mode (which is called a “grayscale inversion”) due to the shape accuracy of the MCCA, thus leading to a decrease in the contrast ratio on the display screen or the degree of visibility.

To overcome such a problem, the applicant of the present application discovered that such dark-state leakage was caused partly due to “twice reflection” and proposed a structure for reducing the influence of such twice reflection (see Patent Document No. 5). As used herein, the “twice reflection” refers to a phenomenon that a part of incoming light that has been incident on a corner cube is reflected by only two out of the three planes that form the corner cube and goes out of the corner cube toward a particular direction without being reflected by the other plane. Such dark-state leakage caused by the twice reflection would pose a serious problem particularly when the viewer is looking from a direction that defines a significant tilt with respect to a normal to the virtual plane of the MCCA.
Patent Document No. 1: Japanese Patent Application Laid-Open Publication No. 5-107538
Patent Document No. 2: Japanese Patent Application Laid-Open Publication No. 2000-19490
Patent Document No. 3: Japanese Patent Application Laid-Open Publication. No. 2002-107519
Patent Document No. 4: Japanese Patent Application Laid-Open Publication No. 11-15415
Patent Document No. 5: Japanese Patent Application Laid-Open Publication No. 2006-215106

### DISCLOSURE OF INVENTION

### Problems to be Solved by the Invention

The present inventors discovered and confirmed via experiments that in a reflective display device with an MCCA, when a viewer positioned in front of the display panel viewed an image on the screen, the brightness of the black display varied according to the direction in which the incoming light was incident on the MCCA (such as its azimuthal direction, among other things). We also discovered that when the incoming light came from a particular azimuth direction, the brightness of the black display increased particularly significantly, thus causing the dark-state leakage. Such dark-state leakage was observed in more than three azimuthal directions from which the incoming light had come, and was also sensed even when the incoming light had as small a polar angle as approximately 15 degrees. That is why the dark-state leakage unique to the MCCA should not have been caused by the “twice reflection” but due to some other factor.

Thus, the present inventors carried out various experiments and measurements to be described later. As a result, we discovered that the variation in the brightness of the black display according to the direction in which the incoming light had come would have been caused mainly due to scattering of light from the ridge and valley portions of the MCCA and scattering of light from the source or gate lines and the black matrix. As used herein, the “ridge portion” refers to a convex portion defined by the lines that connect together the saddle and peak points of each of the corner cubes that form the MCCA, while the “valley portion” refers to a concave portion defined by the lines that connect together the saddle and bottom points of each corner cube. In a conventional reflective display device, when light that has come from a particular direction is incident on its display panel, those two types of scattering would intensify each other, thus producing a significant dark-state leakage.

It is therefore an object of the present invention to increase the display contrast ratio and visibility for a reflective display device, including a retroreflective layer in an MCCA shape, by minimizing such a dark-state leakage to be caused if light that has come from a particular direction is incident on the MCCA.

### Means for Solving the Problems

A reflective liquid crystal display device according to the present invention includes: an optical modulating layer that is switchable, on a pixel-by-pixel basis, between a first state and a second state that have mutually different optical properties in response to a voltage applied; a front substrate and a rear substrate that sandwich the optical modulating layer between them; and a retroreflective layer, which is arranged behind the optical modulating layer and which has a plurality of unit structures that are arranged two-dimensionally on a virtual plane. The reflective liquid crystal display device conducts a display operation by using light that has been reflected back from the retroreflective layer. The device further includes: gate lines, which are arranged on the rear substrate; source lines, which are also arranged on the rear substrate so as to cross the gate lines as viewed from over the front substrate; a switching element, which is also arranged on the rear substrate and which is activated in response to a signal that has been supplied to its associated one of the gate lines; a pixel electrode, which is electrically connectible to its associated one of the source lines by way of the switching element; and a counter electrode, which is arranged so as to face the pixel electrode. Each said unit structure of the retroreflective layer has a recess defined by three planes that are opposed perpendicularly to each other. As viewed from over the front substrate, each of the gate and source lines defines an angle of at least 7 degrees with respect to any of the azimuthal directions that are defined by projecting normals to the three planes of each said unit structure onto the virtual plane.

In one preferred embodiment, as viewed from over the front substrate, the gate lines and the source lines cross each other substantially at right angles. The gate lines define the smallest angle of 7 to 15 degrees with respect to one of the azimuthal directions that are defined by projecting normals to the three planes of each said unit structure onto the virtual plane. And the source lines define the smallest angle of 7 to 15 degrees with respect to another one of the azimuthal directions that are defined by projecting normals to the three planes of each said unit structure onto the virtual plane.

The unit structures are preferably arranged on the retroreflective layer so as to face substantially the same direction.

In another preferred embodiment, the three planes that are opposed perpendicularly to each other to form each said unit structure are all square.

The retroreflective layer preferably has a retroreflectivity of 66% to 100%.

In still another preferred embodiment, the unit structures are arranged on the retroreflective layer at a pitch of 3 μm to 1,000 μm.

The retroreflective layer may be arranged behind the rear substrate.

Alternatively, the retroreflective layer may be arranged between the optical modulating layer and the rear substrate.

### Effects of the Invention

The present invention can increase the contrast ratio on the display screen by minimizing the “dark-state leakage” phenomenon in a reflective display device with a retroreflective layer and also realizes a display operation with good visibility by minimizing the grayscale inversion.

### BRIEF DESCRIPTION OF DRAWINGS

FIGS. 1(a) and 1(b) illustrate the operating principle of a reflective liquid crystal display device in which a scattering liquid crystal display mode is combined with a retroreflector.

FIGS. 2(a) and 2(b) are respectively a plan view and a perspective view illustrating the configuration of a corner cube array.

FIGS. 3(a) and 3(b) are respectively a plan view and a cross-sectional view illustrating how the azimuth angle α and the polar angle β are defined.

FIGS. 4(a) and 4(b) are enlarged plan views schematically illustrating how scattering of light is caused by ridge and valley portions of an MCCA.

FIG. 5 is a plan view schematically illustrating a typical arrangement of source lines and gate lines on the rear substrate of a reflective display device to show how scattering of light is caused by the source lines, the gate lines or a black matrix.

FIG. 6(a) is an enlarged plan view illustrating a relative arrangement of the source lines and gate lines with respect to the corner cube array of a conventional display device. And FIG. 6(b) is a graph schematically showing a relation between the light incoming direction (represented by the azimuth angle) and the intensity of the scattered light in the conventional reflective display device in a black display state.

FIG. 7(a) is a plan view illustrating the arrangement of source lines and gate lines in a reflective display device as a first preferred embodiment of the present invention. FIG. 7(b) is a schematic cross-sectional view of the reflective display device of the first preferred embodiment. And FIG. 7(c) is a plan view illustrating the relative arrangement of the corner cube array, source lines and gate lines according to the first preferred embodiment.

FIGS. 8(a) and 8(b) are respectively a cross-sectional view and a plan view schematically illustrating the arrangement of a photodetector and a light source with respect to a display device as a test sample or a reference sample.

FIG. 9 is a graph showing how the intensity of scattered light as measured perpendicularly to a front substrate changed according to the azimuth angle A of a light incoming direction in display devices in a black display state representing test and reference samples.

FIG. 10 is a graph showing how the maximum scattered light intensity as measured perpendicularly to the front substrate changed with the angles γs and γg in a situation where the light had been incident from a particular direction (in which α=90 degrees and β=30 degrees).

FIG. 11 is a graph showing how the intensity of the scattered light as measured perpendicularly to the front substrate changed according to the light incoming direction (represented by the azimuth angle A) in a display device according to a preferred embodiment of the present invention.

FIG. 12(a) is a plan view illustrating the angles γs and γg formed between the azimuthal directions x, y, z defined by projecting, onto a virtual plane, normals to the three planes of each of the corner cubes that form the corner cube array and the azimuthal directions of source and gate lines, and FIG. 12(b) is a graph showing an exemplary range of those angles γs and γg.

FIGS. 13(a) through 13(c) are top views illustrating alternative corner cube arrays that could be used in preferred embodiments of the present invention.

FIG. 14 is a plan view illustrating another exemplary arrangement of source and gate lines with respect to a corner cube array in an alternative preferred embodiment of the present invention.

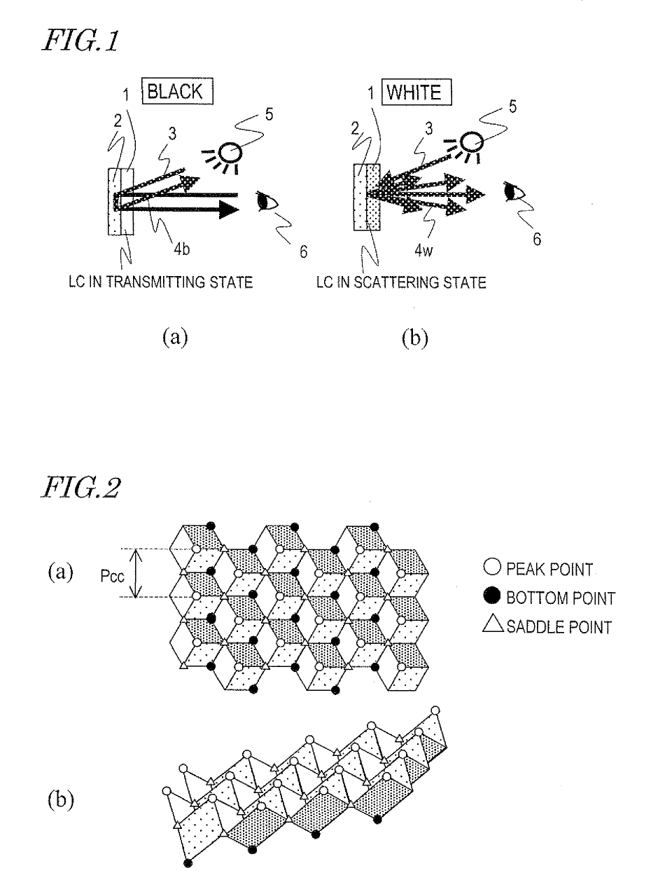

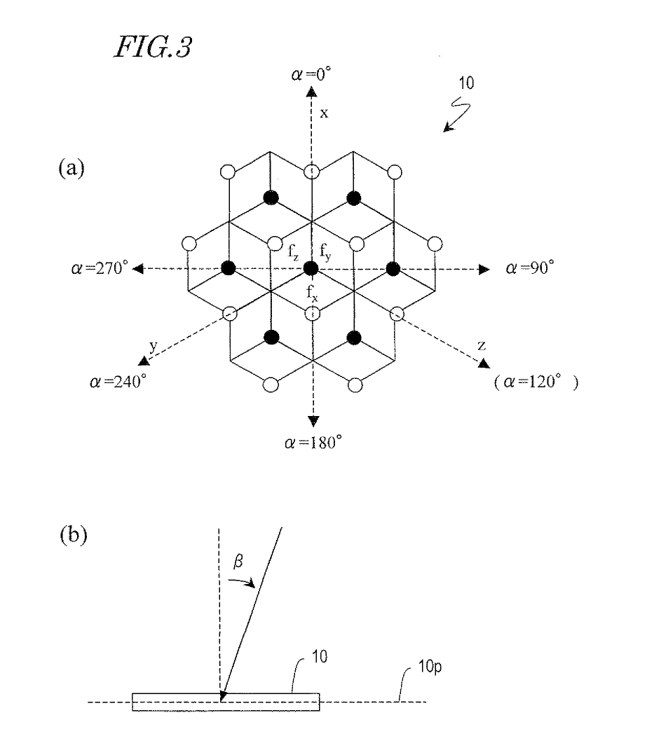

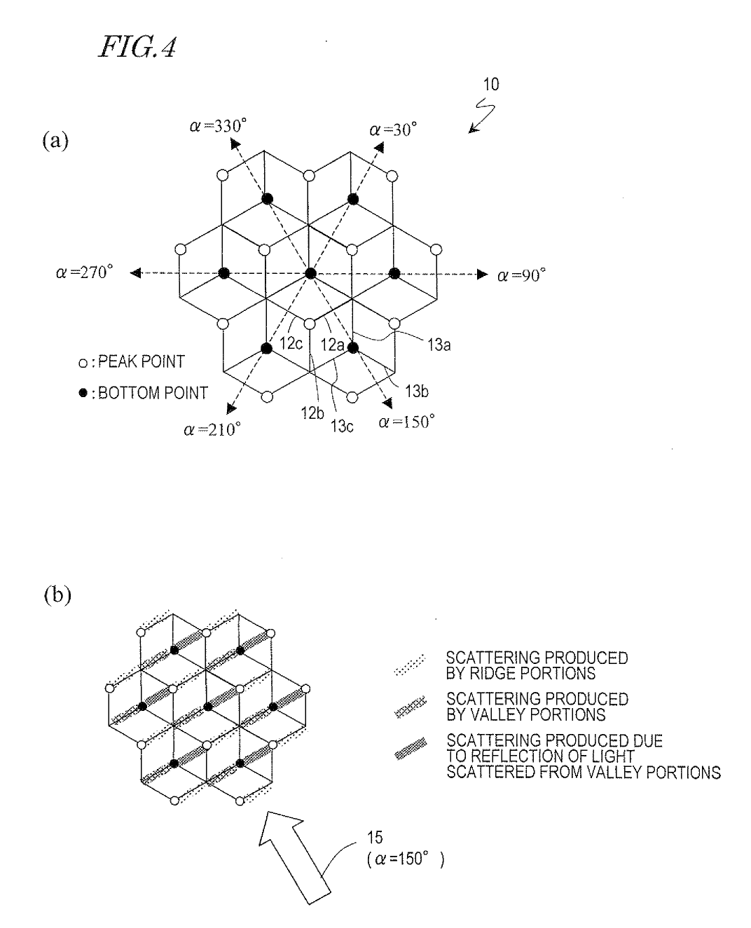

### DESCRIPTION OF REFERENCE NUMERALS

10 corner cube array
30 front substrate
31 liquid crystal layer
32 rear substrate
33 switching element (thin-film transistor)
34 source line
35 gate line
36 pixel electrode
38 counter electrode
39 color filter
40 black matrix
42 resin layer
44 metal layer
46 gas
fx, fy, fz planes that form a corner cube
x, y, z azimuthal directions defined by normals to the fx, fy and fz planes that form a corner cube
100 display device

### BEST MODE FOR CARRYING OUT THE INVENTION

In order to overcome the problem with a conventional reflective display device with a retroreflective layer (MCCA), the present inventors carried out various researches and measurements on a reflective display device with a cubic corner cube array as an example. The results of those researches and measurements will now be described in detail.

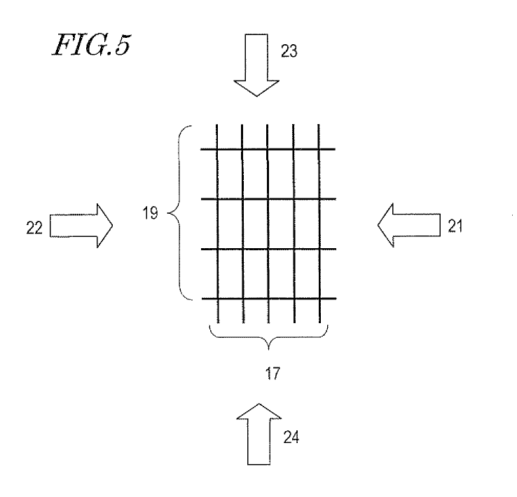

In the following description, the direction in which incoming light is incident on an MCCA (which will be simply referred to herein as “light incoming direction”) will be defined by the azimuth angle α and polar angle β. FIGS. 3(a) and 3(b) are respectively a plan view and a cross-sectional view illustrating how the azimuth angle α and the polar angle β are defined. As shown in FIG. 3(a), the azimuth angles α are defined clockwise on a plan view of a corner cube array 10 by reference to one of three normals to the three planes that are opposed perpendicularly to each other to form a corner cube (i.e., fx, fy and fz planes). That is to say, α=0 on that reference normal. In the example illustrated in FIG. 3(a), the azimuth angles α are defined by reference to the normal x to the fx plane, and the normals y and z to the fy and fz planes are defined by α=240 degrees and α=120 degrees, respectively. On the other hand, the polar angle β refers herein to the tilt angle from a normal to the virtual plane 10p of the corner cube array 10 as shown in FIG. 3(b). Generally speaking, if something is perpendicular to the virtual plane 10p of the corner cube array 10, then it is also perpendicular to the surface of the display panel of the display device (i.e., the front substrate). That is why “a normal to the virtual plane of the corner cube array” agrees with “a normal to the surface of the display panel (or front substrate)”.

As described above, the present inventors concluded that the black display performance varied according to the light incoming direction due to scattering from the ridge and valley portions of the MCCA and due to scattering from the source or gate lines and the black matrix.

First of all, it will be described how the incoming light gets scattered from the ridge and valley portions of the MCCA. FIG. 4(a) is a plan view illustrating the incoming direction (i.e., azimuthal direction) of light that will cause such scattering.

The present inventors carried out observations on the display panel from the front of the display panel (i.e., perpendicularly to the virtual plane of the corner cube array 10) with the light incoming directions changed with respect to the corner cube array 10. As a result, we discovered that if the polar angle β defined by the light incoming direction with respect to the corner cube array 10 was greater than 0 degrees but less than about 30 degrees, the dark-state leakage intensified at azimuth angles α of around 30, 90, 150, 210, 270 and 330 degrees in the light incoming directions. As can be seen from FIG. 4(a), the direction of each of these azimuth angles α intersects at right angles with any of the ridge portions (i.e., convex portions defined by lines that connect together the saddle and peak points of corner cubes) 12a, 12b and 12c or any of the valley portions (i.e., concave portions defined by lines that connect together the saddle and bottom points of corner cubes) 13a, 13b and 13c on the plan view of the corner cube array 10. For example, the directions in which the azimuth angles α are 150 degrees and 330 degrees intersect at right angles with the ridge portion 12a and the valley portion 13c on the plan view of the corner cube array 10. On the other hand, the directions in which the azimuth angles α are 90 degrees and 270 degrees intersect at right angles with the ridge portion 12b and the valley portion 13a. In other words, if the light incident on the corner cube array 10 had come from any of the directions that are perpendicular to the ridge portions 12a, 12b and 12c and the valley portions 13a, 13b and 13c, the dark state leakage intensified.

Such an intense dark-state leakage that was observed if the light incident on the corner cube array 10 had come from any of the directions defined by those particular azimuth angles α would have been caused by scattering from the ridge and valley portions of the corner cube array 10 in a bad shape.

Generally speaking, if an MCCA in which corner cubes are arranged at a very small pitch (of 200 μm or less, for example) was made, then the shape of the MCCA actually obtained would get somewhat “inaccurate” compared to the ideal one, no matter what method was adopted to make it. At the peak and bottom points and in the ridge and valley portions of each of the corner cubes that form the MCCA, among other things, the shape inaccuracy would be particularly significant. As used herein, examples of the shape “inaccuracy” include rounding, burring, roughening and denting. Thus, the dark-state leakage described above would be caused by scattering of the incoming light, which has come from an azimuthal direction that intersects with the ridge or valley portion at right angles, from the ridge or valley portion with significant shape inaccuracy.

Such scattering from the ridge or valley portion can be confirmed by carrying out the following experiment. If the incoming light is incident on the corner cube array 10 from a direction in which the azimuth angle α is 150 degrees (and in which the polar angle β is greater than 0 degrees but less than 30 degrees) and if the corner cube array 10 is observed with a microscope perpendicularly to the virtual plane of the corner cube array 10, scattering of light will be observed along a number of lines that are parallel to each other as shown in FIG. 4(b). Those lines (defined by the azimuth angles α of 60 degrees and 240 degrees) intersect with the light incoming direction 15 at right angles. Thus, the dark-state leakage would have been intensified because scattering of the incoming light from the ridge portions, scattering of the incoming light from the valley portions, and reflection of that light scattered from the valley portion by a plane opposed to the valley portion would have occurred simultaneously with each other.

Next, the scattering from a source line, a gate line or black matrix will be described.

FIG. 5 is a plan view illustrating a typical arrangement of source lines and gate lines on the rear substrate of a reflective display device. As shown in FIG. 5, the source lines 17 and gate lines 19 are normally arranged so as to intersect with each other at right angles. Also, although not shown, a black matrix provided for a counter substrate is usually arranged parallel to the source lines 17 and/or gate lines 19. In such a display device, if light is incident on the device perpendicularly to an edge of any source line 17, any gate line 19 or the black matrix, then the scattering of the light will intensify particularly perpendicularly to the front substrate. For example, if the light is incident on the source lines 17 from the azimuthal directions indicated by the arrows 21 and 22, then the scattering of the incoming light from the source lines 17 as measured perpendicularly to the front substrate will get maximized (i.e., a peak of scattering will be reached). In the same way, if the light is incident on the gate lines 19 from the azimuthal directions indicated by the arrows 23 and 24, then the scattering of the incoming light from the gate lines 19 as measured perpendicularly to the front substrate will get maximized, too.

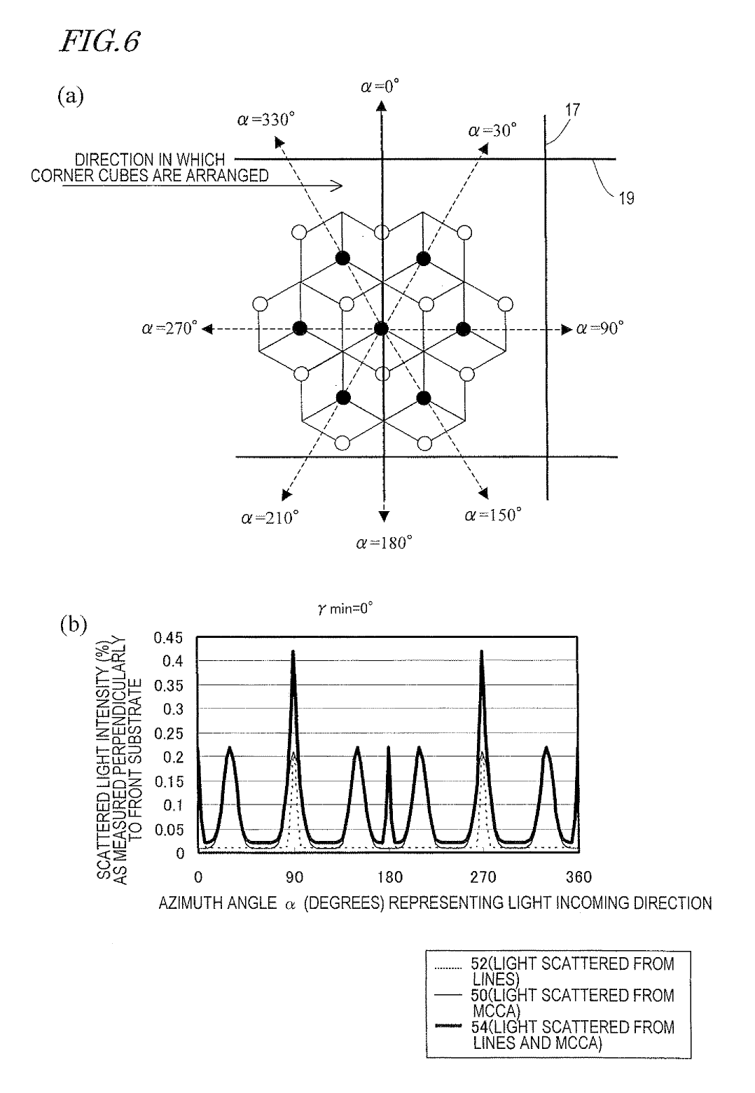

Hereinafter, the relation between those two types of scattering and the light incoming direction in a conventional display device will be described with reference to FIGS. 6(a) and 6(b).

FIG. 6(a) is a plan view illustrating the relative arrangement of the source lines 17 and gate lines 19 with respect to the corner cube array 10 in a conventional display device. In the conventional reflective display device, either the source lines 17 or the gate lines 19 are arranged in the direction in which the corner cubes are arranged in the corner cube array 10. As used herein, the “direction in which the corner cubes are arranged” refers to the direction in which either the bottom points or peak points of corner cubes that are adjacent to each other in a plan view of a corner cube array are connected together. Such an arrangement is adopted partly because the lines 17 and 19 are arranged with respect to the corner cube array 10 so as to reduce the number of corner cubes to be partially overlapped by the lines 17 and 19. Then, it is possible to prevent the retroreflectivity from decreasing due to that partial overlap of the lines 17 and 19 with the corner cube array 10. Also, such an arrangement is preferred because the process would advance more smoothly with such an arrangement.

FIG. 6(b) schematically shows the relation between the light incoming direction (represented by the azimuth angle α) in the black display state and the intensity of the scattered light as measured perpendicularly to the front substrate of a display device in which the corner cube array 10 and the lines 17 and 19 are arranged as shown in FIG. 6(a). In this case, the polar angle β in the light incoming direction is supposed to be 30 degrees. Also, the “scattered light intensity (%)” on the axis of ordinates of this graph represents the relative intensity of the scattered light with respect to the intensity of light to go perpendicularly to a total diffuser in a situation where the light is incident on the total diffuser from a direction in which the polar angle β is 30 degrees. The higher the intensity of that scattered light, the brighter the black display state will look for the viewer positioned in front of the display device.

The curve 50 represents the intensity of the light that has been scattered from a ridge or valley portion of the corner cube array 10 to go perpendicularly to the front substrate and, has peaks when the azimuth angle α of the light incoming direction is 30, 90, 150, 210, 270 or 330 degrees. On the other hand, the curve 52 represents the intensity of the light that has been scattered from the source line 17, gate line 19 or black matrix to go perpendicularly to the front substrate and has peaks when the azimuth angle α of the light incoming direction is 90, 180, 270 or 360 degrees. And the curve 54 represents the sum of the intensities of the scattered light represented by the curves 50 and 52. As can be seen from this curve 54, if light has been incident on the display device from a direction in which the azimuth angle α is 90 degrees or 270 degrees, then the two types of peaks of scattering described above will intensify each other to generate an outstanding peak. As a result, the brightness in the black display state will increase excessively and the contrast ratio on the display screen and the visibility will drop steeply.

Based on the results of these researches and measurements, the source lines, gate lines and MCCA are arranged according to the present invention so that the peak of the intensity of the light scattered from the MCCA and the peaks of the intensities of the light scattered from the source lines, gate lines and black matrix will not overlap with each other, thereby minimizing the dark state leakage and the grayscale inversion.

### Embodiment 1

Hereinafter, a First Specific Preferred Embodiment of a reflective display device according to the present invention will be described with reference to the accompanying drawings. The reflective display device of the first preferred embodiment is a retroreflective display device with an MCCA attached structure in which a retroreflective layer (MCCA) is arranged behind its display panel.

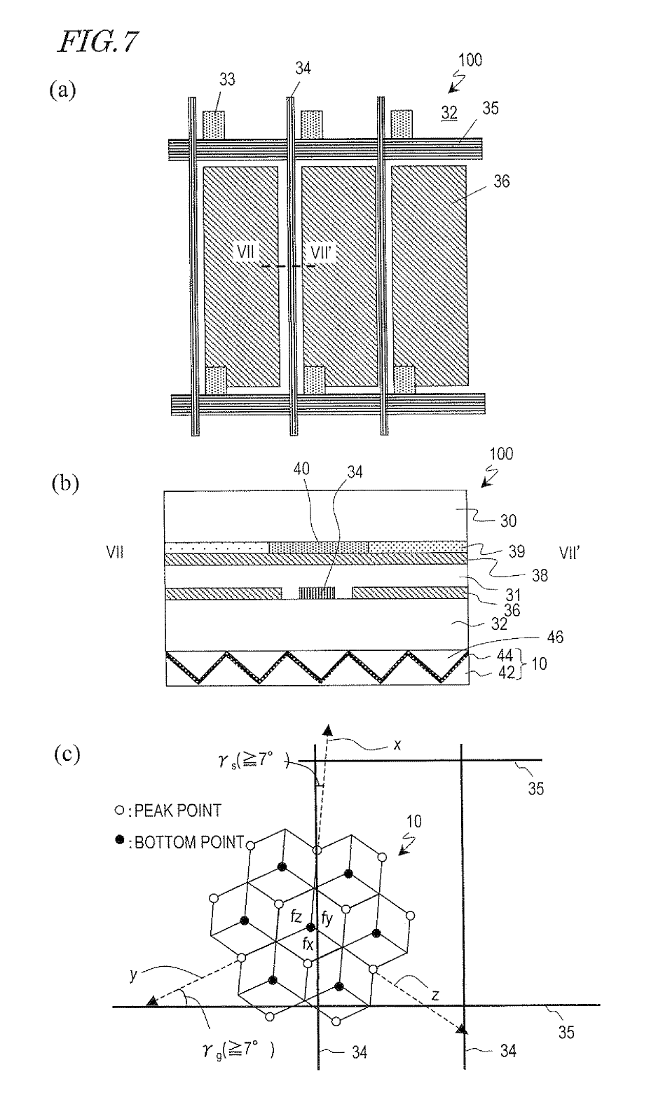

FIGS. 7(a) through 7(c) illustrate a reflective display device as the first preferred embodiment. Specifically, FIG. 7(a) is a plan view illustrating the arrangement of lines and electrodes on the rear substrate of the reflective display device of this preferred embodiment. FIG. 7(b) is a schematic cross-sectional view of the reflective display device as viewed on the plane VII-VII′. And FIG. 7(c) is a schematic enlarged plan view illustrating the relative arrangement of the corner cube array, source lines and gate lines according to this preferred embodiment.

The display device 100 includes a front substrate 30 and a rear substrate 32 that is arranged so as to face the front substrate 30. And between these substrates 30 and 32, there is a scattering type liquid crystal layer 31 that can switch from a scattering state into a transmitting state, and vice versa.

On the surface of the rear substrate 32, arranged to face the liquid crystal layer 31 are a number of thin-film transistors (TFTs) 33 functioning as switching elements, a number of pixel electrodes 36, source line 34, each of which is connected to an associated one of the pixel electrodes 36 by way of its associated TFT, and gate lines 35 for selectively turning ON the TFTs 33. The pixel electrodes 36 are made of a light-transmitting conductive material such as ITO (indium tin oxide). As shown in FIG. 7(b), the pixel electrodes 36 are arranged so as to be spaced from each other, thereby defining pixel as units of image display. The source lines 34 and the gate lines 35 intersect with each other when viewed perpendicularly to the front substrate 30. Although not shown in FIG. 7, the source lines 34 and gate lines 35 are respectively connected to a source driver and a gate driver of the driver circuit on the rear substrate 32. These lines 34 and 35 are usually made of an opaque metallic material such as tantalum. Meanwhile, on the other side of the rear substrate 32, the corner cube array 10 is arranged opposite to the liquid crystal layer 31. In this preferred embodiment, the corner cube array 10 includes a resin layer 42 that defines the shape of the corner cube array and a metal layer 44 deposited on the resin layer 42. The gap between the corner cube array 10 and the rear substrate 32 may be filled with the air with a refractive index of 1.00 or a transparent resin with a refractive index of approximately 1.5, for example.

On the front substrate 30, on the other hand, arranged are color filters 39, a black matrix 40 and a counter electrode 38 made of a transparent conductive film. The color filters 39 are arranged to face the respective pixels. And the black matrix 40 is arranged between adjacent pixels and around display areas, if necessary, to shield the lines 34 and 35 and the thin-film transistors 33 from incoming light.

In this preferred embodiment, when viewed perpendicularly to the front substrate 30, the source lines 34 and the gate lines 35 cross each other at right angles. And the black matrix 40 is arranged on the front substrate 30 substantially parallel to those lines 34 and 35 so as to shield the lines 34 and 35 from incoming light.

This display device 100 can switch the liquid crystal layer 31 between a scattering state and a transmitting state by controlling the voltage applied between the counter electrode 38 and the pixel electrodes 36.

Next, it will be described with reference to FIG. 7(c) how the corner cube array 10 needs to be arranged with respect to the source lines 34 and the gate lines 35. In this preferred embodiment, when viewed perpendicularly to the front substrate 30, each of the gate lines 35 and the source lines 34 is arranged so as to define an angle of at least 7 degrees with respect to any of the azimuthal directions x, y and z that are defined by projecting, onto a virtual plane, normals to the fx, fy and fz planes of each unit structure (i.e., each corner cube) of the corner cube array 10. That is to say, supposing the smallest angle defined by one of the three azimuthal directions x, y and z with respect to the source lines 34 (e.g., the azimuthal direction x in this case) is identified by γs and the smallest angle defined by another one of the three azimuthal directions x, y and z with respect to the gate lines 35 (e.g., the azimuthal direction y in this case) is identified by γg when viewed perpendicularly to the front substrate 30, the smaller one of these two angles γs and γg (which will be referred to herein as an “angle γₘᵢₙ”) becomes at least 7 degrees. It should be noted that on the virtual plane of the corner cube array 10, the azimuthal directions x, y and z are parallel to the ridge portions or valley portions of the corner cube array 10. That is why the angles defined by the azimuthal directions x, y and z with respect to the source lines 34 and gate lines 35 are the same as the angles defined by the ridge portions or the valley portions with respect to those lines 34 and 35.

In the corner cube array 10 of this preferred embodiment, each and every one of its corner cubes is arranged so as to face substantially the same set of directions. Specifically, the azimuth angles α of normals to the three planes that form each and every corner cube are 0, 120 and 240 degrees. From the standpoint of retroreflectivity, the corner cube array 10 is preferably a cubic corner cube array consisting of corner cubes, each being formed by three square planes that are opposed perpendicularly to each other.

According to the arrangement shown in FIG. 7(c), an angle of at least 7 degrees can be formed between the azimuthal directions of the ridge and valley portions of the corner cube array 10 and those of the source lines 34 and the gate lines 35. That is why as viewed perpendicularly to the front substrate 30, no matter from what azimuthal direction the incoming light is coming, the peaks of the intensities of the light scattered from the ridge and valley portions of the corner cube array 10 will never overlap with those of the intensities of the light scattered from the source lines 34, gate lines 35 or the black matrix 40. As a result, the significant dark state leakage described above can be avoided.

This point will be described in detail by way of experimental examples.

### Measurement of Scattered Light Intensity in Black Display State

The present inventors measured the intensities of scattered light that were leaving a display device with the configuration that has already been described with reference to FIGS. 7(a) to 7(c) (as a test sample) and a conventional display device (as a reference sample) perpendicularly to the front substrate in the black display state.

First of all, the test sample and the reference sample were provided. Both of those test and reference samples used a cubic corner cube array with an arrangement pitch of 24 μm as the corner cube array 10, which exhibited a retroreflectivity of 60%. The retroreflectivity (=the intensity of reflected light/the intensity of incoming light (%)) of a corner cube array may be measured with any known device. Or if the corner cube array had a particularly small arrangement pitch (e.g., 30 μm or less), then the retroreflectivity could be measured by the method disclosed by the applicant of the present application in Japanese Patent Application Laid-Open Publication No. 2005-128421, for example. Also, the source lines 34 and the gate lines 35 were arranged so as to cross each other at right angles when viewed over the front substrate. And each pixel had a rectangular shape with dimensions of 210 μm by 70 μm when viewed from over the front substrate. Furthermore, as for the test sample, the smallest angle γₘᵢₙ formed between one of the three azimuthal directions, which were defined by projecting, onto a virtual plane, normals to the three planes of each of the unit structures (corner cubes) that form the corner cube array 10, and the source lines 34 and the gate lines 35 was 15 degrees (i.e., γₘᵢₙ=15 degrees). As for the reference sample, on the other hand, the corner cube array was arranged so that the angle γₘᵢₙ became equal to zero degrees (i.e., γₘᵢₙ=0 degrees).

Next, the light that had been emitted from a light source was made to incident on the test and reference samples, the light reflected and leaving the samples perpendicularly to the front substrate was received, and then its intensity (i.e., the received light intensity) was measured.

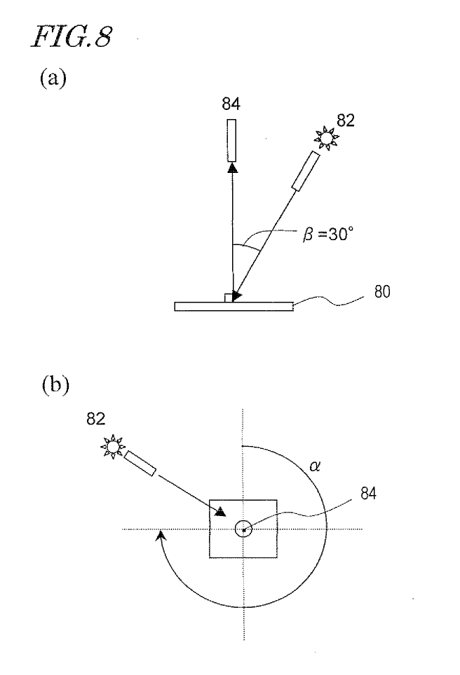

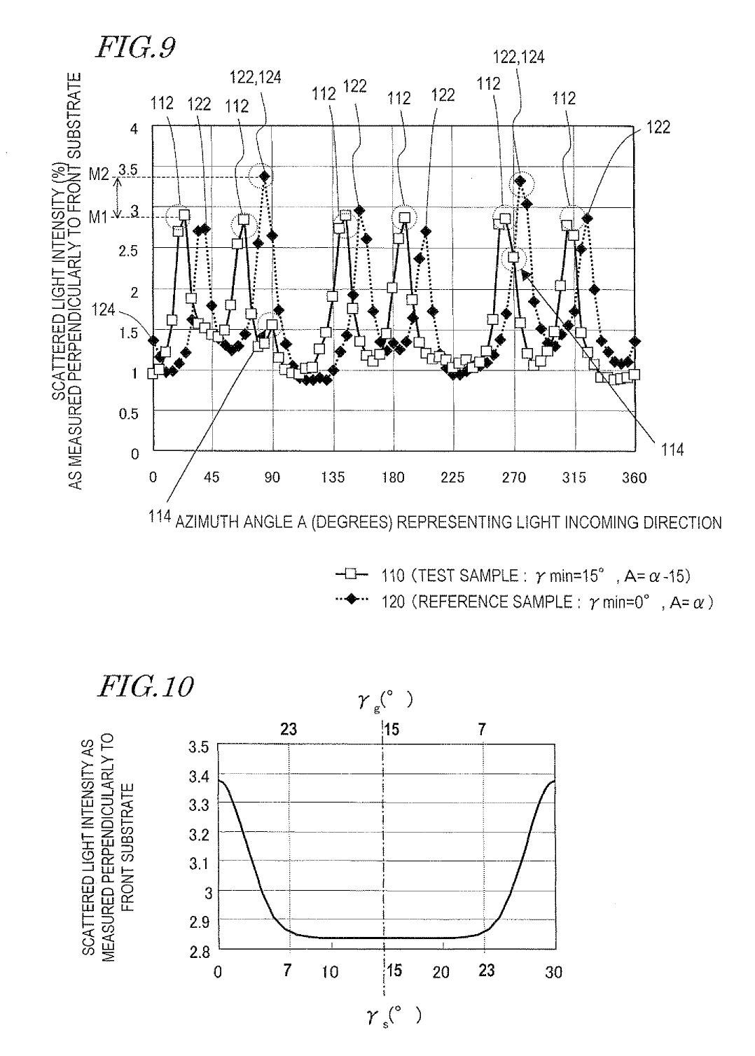

FIGS. 8(a) and 8(b) are respectively a cross-sectional view and a plan view schematically illustrating the arrangement of a photodetector 84 and a light source 82 with respect to a display device 80. As shown in FIG. 8(a), the photodetector 84 was arranged so as to receive a light ray that had been reflected perpendicularly to the display panel of the display device 80 (represented by (α=0, β=0)). The photodetector 84 was supposed to have a light receiving angle of 3 degrees. Meanwhile, the intensity of the scattered light was measured with the light source 82 moved such that the light emitted from the light source 82 would enter the display panel from the directions in which the polar angle β was fixed at 30 degrees and the azimuth angle α (i.e., the angle of incidence) changed within the range of 0 through 360 degrees as shown in FIGS. 8(a) and 8(b).

The results of the measurements are shown in FIG. 9. The line graphs 110 and 120 shown in FIG. 9 represent the relations between the azimuth angle and the intensity of the scattered light that was measured (at the photodetector 84) perpendicularly to the front substrate in the test and reference samples, respectively. In FIG. 9, the abscissa represents the azimuth angle. In this example, the azimuth angle α defined by using the corner cube shown in FIG. 3(a) as a reference is replaced with the azimuth angle A defined by using the source line direction as a reference. It should be noted that the “scattered light intensity (%)” is supposed to be measured when the intensity of a light ray that has come from a direction in which the polar angle β is 30 degrees with respect to a total diffuser and then received by a photodetector that is arranged in a direction in which the polar angle β is zero degrees is 100%.

In the test sample, the intensity of the scattered light in the black display state changed significantly according to the azimuth angle α as indicated by the line graph 110. Specifically, when the azimuth angle A was in the vicinity of 15, 75, 135, 195, 255 and 315 degrees, peaks 112 that had been produced as a result of scattering of light from the ridge and valley portions of the corner cube array 10 was observed. On the other hand, when the azimuth angle A was in the vicinity of 0, 90, 180 and 270 degrees, peaks 114 (some of which are not shown in FIG. 9) that had been produced as a result of scattering from the source lines, gate lines and black matrix were observed. However, since none of those peaks 112 and 114 overlapped with each other, no outstanding peaks were produced. Consequently, the maximum value (i.e., the maximum scattered light intensity) M1 of all of those peaks 112 and 114 was approximately 2.8%.

In the reference sample, on the other hand, when the azimuth angle α was in the vicinity of 30, 60, 120, 180, 240 and 300 degrees, peaks 122 that had been produced as a result of scattering of light from the ridge and valley portions of the corner cube array 10 were observed as indicated by the line graph 120. On the other hand, when the azimuth angle α was in the vicinity of 0, 90, 180 and 270 degrees, peaks 124 (some of which are not shown in FIG. 9) that had been produced as a result of scattering from the source lines, gate lines and black matrix were observed. Consequently, those peaks 122 and 124 overlapped with each other at azimuth angles α of approximately 90 degrees and approximately 270 degrees to produce outstanding peaks. The received light intensity (i.e., the maximum scattered light intensity) M2 of such peaks was approximately 3.4%, which was about 0.6% higher than the maximum scattered light intensity M1 of the test sample. As a result, the ratio of the difference in maximum scattered light intensity between the test and reference samples to the maximum scattered light intensity M2 of the reference sample was approximately 17%.

The results of these measurements revealed that the reference sample had particularly high scattered light intensity and produced a significant dark state leakage when the light was incident at a particular azimuth angle α. But the present inventors also discovered that the test sample could reduce the maximum scattered light intensity by approximately 17% and could avoid such a significant dark state leakage because the azimuth angle α at which the light was scattered from the ridge and valley portions of the corner cube array 10 was different from the azimuth angle α at which the light was scattered from the source lines, gate lines or black matrix.

Consequently, the present inventors confirmed that since there was no light source direction (i.e., the azimuthal direction of the light incoming direction) in which such a significant dark state leakage was produced, good black display performance was achieved and the contrast ratio on the screen and the visibility could be increased according to this preferred embodiment.

### Relation Between Scattered Light Intensity and Angles γs and γg in Black Display State

The present inventors looked into the relation between the peak of the scattered light intensity (i.e., the maximum scattered light intensity) as measured perpendicularly to the front substrate and the angles γs and γg. The results are shown in FIG. 10. In this case, a display device having the same configuration as the test sample described above was used except that the arrangement of the corner cube array with respect to the lines (i.e., the angles γs and γg) was changed. Also, the azimuth angle α and the polar angle in the light incoming direction were supposed to be 90 degrees and 30 degrees, respectively. As described above, the angle γs is the smallest angle defined by one of the three azimuthal directions x, y and z with respect to the source lines as viewed from over the front substrate, while the angle γg is the smallest angle defined by another one of the three azimuthal directions x, y and z with respect to the gate lines as viewed from over the front substrate. In the display device used in this experiment, the source lines and gate lines crossed each other at right angles when viewed from over the front substrate, and therefore, the sum of the angles γs and γg was 30 degrees.

As can be seen from the results shown in FIG. 10, when the angle γs or the angle γg was less than 7 degrees, the maximum scattered light intensity could not be reduced sufficiently. This is probably because the intensity of the light scattered from the source lines, gate lines or black matrix was so close to the peak value that the peak of that scattered light intensity and that of the intensity of the light scattered from the corner cube array would have overlapped with each other. The present inventors also discovered that if both of those angles γs and γg were equal to or greater than 7 degrees (i.e., if γₘᵢₙ≧7 degrees), the two peaks of scattering could be shifted from each other so that the maximum scattered light intensity could be reduced significantly.

As described above, in the conventional reflective display device, in order to minimize the deterioration of the retroreflectivity by reducing the number of corner cubes, which are covered with lines at least partially, the lines and the corner cubes are arranged to face the same direction. However, the present inventors discovered and confirmed via experiments that in an MCCA attached structure, the lines and the MCCA were arranged so as to leave a gap that was at least as great as the thickness of the rear substrate, and therefore, the degree of deterioration of the retroreflectivity caused by such corner cubes that were partially covered with those lines was not so great, considering the magnitude of shift of the retroreflected light. That is why the effect of reducing the dark state leakage by tilting the MCCA by at least 7 degrees with respect to the lines would be of greater influence on the display performance than the disadvantage to be caused when the lines and the MCCA are not arranged to face the same direction. Consequently, the display device of this preferred embodiment would realize higher display performance than the conventional display device.

The present invention will achieve particularly significant effects if the corner cube array 10 for use in the display device has a high degree of shape accuracy. According to the results of experiments that have already been described with reference to FIG. 9, the maximum scattered light intensity M1 of the test sample was approximately 17% lower than the maximum scattered light intensity M2 of the reference sample. However, the higher the shape accuracy of the corner cube array 10, the lower the intensity of the light scattered from the corner cube array 10 will be. In that case, the maximum scattered light intensity can be further reduced and more significant effects will be achieved. If the intensity of the light scattered from the ridge and valley portions of the corner cube array 10 is reduced to the vicinity of that of the light scattered from the source lines, gate lines or black matrix by increasing the degree of shape accuracy of the corner cube array 10, then the maximum scattered light intensity can be almost halved compared to that of the conventional device (i.e., (M2−M1)/M1=0.5). As a result, the dark state leakage caused by the light that has come from a particular direction can be reduced more effectively.

The shape accuracy of the corner cube array 10 can be evaluated by measuring the retroreflectivity of the corner cube array. If a corner cube array that would achieve a retroreflectivity of 66% to 100% is used, for example, then the shape inaccuracy can be reduced sufficiently.

The corner cube array 10 of this preferred embodiment may be made in the following manner, for example. First of all, as in the method disclosed by the applicant of the present application in Japanese Patent Application Laid-Open Publication No. 2003-66211, a master with the shape of a corner cube array is formed by performing an anisotropic etching process on a crystal substrate. Next, that shape is transferred onto a resin material to form a resin layer 42. After that a metal layer (of Ag, for example) is deposited on the resin layer 42, thereby obtaining a corner cube array 10.

The corner cube array 10 preferably has an arrangement pitch of at least 3 μm. This is because if the arrangement pitch is 3 μm or more, the corner cube array 10 can be formed more accurately by the method described above, and therefore, good retroreflective characteristics will be realized. On top of that, the dark state leakage can be reduced more effectively by applying the present invention as well. Nevertheless, the arrangement pitch is preferably at most 1,000 μm. The reason is that such an arrangement pitch of 1,000 μm or less can be approximately a half or less of the diameter of human pupils, and therefore, good black display state can be realized.

Hereinafter, the black display performance of the display device 100 of this preferred embodiment will be described. In the following example, a cubic corner cube array that was made by the method described above so as to have an arrangement pitch of 24 μm and a retroreflectivity of 66% was used as the corner cube array 10. Also, the smallest angle γₘᵢₙ formed between one of the three azimuthal directions x, y and z, which are defined by projecting, onto the virtual plane, normals to the three planes of each of the unit structures (corner cubes) that formed the corner cube array 10, and the source lines 34 and the gate lines 35 was supposed to be 15 degrees as viewed perpendicularly to the front substrate 30.

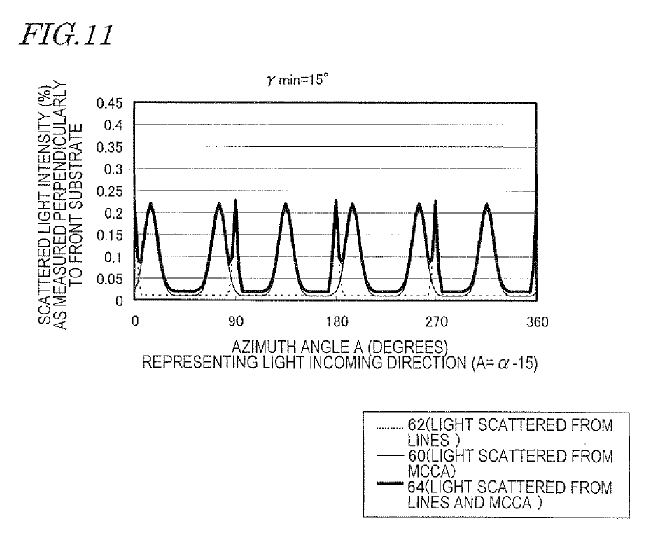

FIG. 11 is a graph showing how the intensity of the scattered light as measured perpendicularly to the front substrate changed according to the light incoming direction (i.e., the azimuth angle A) of the display device 100 in the black display state. In this case, the light incoming direction was supposed to have a polar angle β of 30 degrees. The scattered light intensity (%), represented by the ordinate of this graph, is defined in the same way as in FIG. 9.

In FIG. 11, the curve 60 represents the intensity of the light that had been scattered from the corner cube array 10 and then leaving the device perpendicularly to the front substrate 30, and had peaks when the light incoming direction had an azimuth angle A of 15, 75, 135, 195, 255 or 315 degrees. On the other hand, the curve 62 represents the intensity of the light that had been scattered from the source lines 34, gate lines 35 or the black matrix 40 and then leaving the device perpendicularly to the front substrate 30, and had peaks when the light incoming direction had an azimuth angle A of 0, 90, 180, or 270 degrees. In this case, the peaks at these intensities never overlapped with each other. That is why even if these intensities of light were added together, the maximum value of the scattered light intensity would be substantially equal to the respective peaks of the curves 60 and 62 as represented by the curve 64. Consequently, it can be seen that no matter from what azimuthal direction the incoming light had came, no outstanding peak was observed unlike the situation where γₘᵢₙ was zero degrees as in FIG. 6(b), for example, and therefore, no significant dark state leakage was sensed.

Hereinafter, it will be described more specifically, with reference to the accompanying drawings, where the corner cube array 10 should be arranged with respect to the source lines 34 and the gate lines 35 in a situation where those lines 34 and 35 cross each other at right angles as viewed from over the front substrate 30.

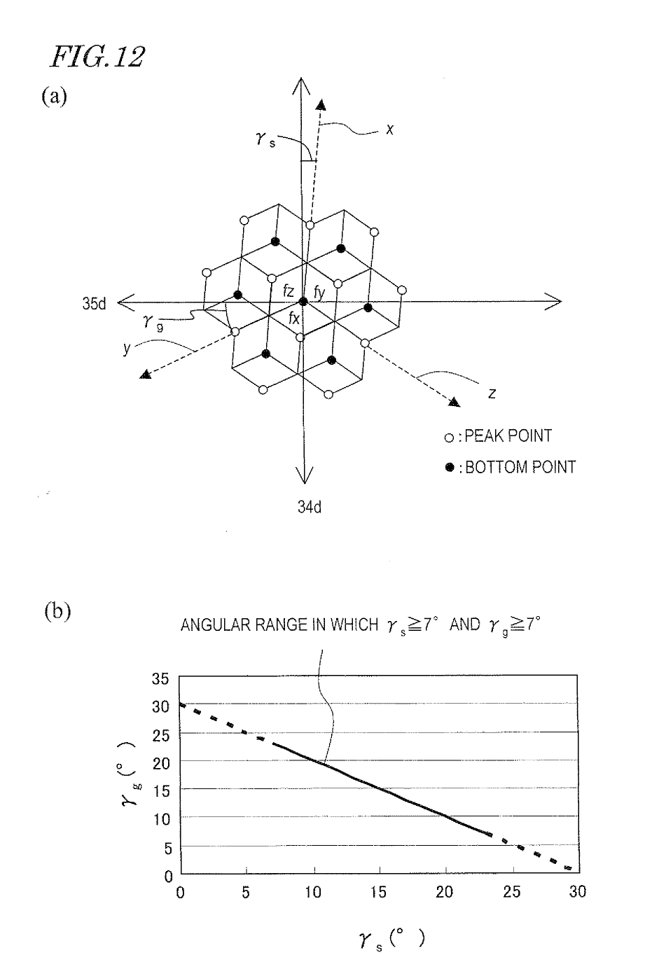

FIG. 12(a) is a plan view as viewed from over the front substrate, illustrating exemplary relations between the respective directions 34d and 35d in which the source line and gate line extend and the azimuthal directions x, y, z defined by projecting, onto a virtual plane, normals to the three planes of each of the unit structures (corner cubes) that form the corner cube array 10. To realize the arrangement described above (i.e., to meet γₘᵢₙ≧7 degrees), the smallest angle γs defined by one of three azimuthal directions x, y and z with respect to the direction 34d in which the source line extends (i.e., the azimuthal direction x in this example) should be at least 7 degrees, and the smallest angle γg defined by another one of the three azimuthal directions x, y and z with respect to the direction 35d in which the gate line extends (i.e., the azimuthal direction y in this example) should also be at least 7 degrees. In this case, if those directions 34d and 35d in which the source and gate lines extend intersect with each other at right angles, then the sum of the angles γs and γg will be 30 degrees (i.e., γs+γg=30 degrees). Then, to make both of the angles γs and γg at least equal to 7 degrees i.e., to meet γs≧7 degrees and γg≧7 degrees), both of these angles γs and γg need to fall within the range of 7 degrees through 15 degrees (i.e., 7 degrees≦γs≦15 degrees and 7 degrees≦γg≦15 degrees need to be satisfied). In the example illustrated in FIG. 12, the angles γs and γg are equal to or smaller than 15 degrees. However, the upper limit of these angles γs and γg will vary according to the angle formed between the directions 34d and 35d in which the source and gate lines extend.

The display device of this preferred embodiment does not have to have the configuration that has already been described with reference to FIGS. 7(a) through 7(c).

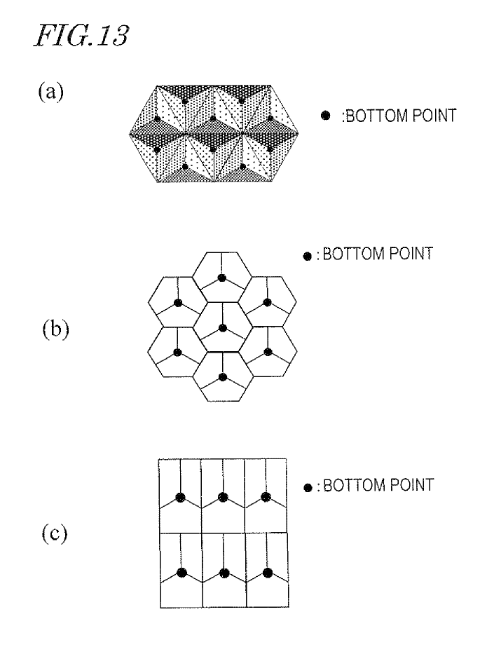

The corner cube array 10 of this preferred embodiment just needs to have a structure in which a number of unit structures, each having a recess defined by three planes that are opposed perpendicularly to each other (i.e., a corner cube), are arranged two-dimensionally. And therefore, the corner cube array 10 does not have to be a cubic corner cube array. FIGS. 13(a) through 13(c) are plan views illustrating alternative corner cube arrays.

In the MCCA illustrated in FIG. 13(a), arranged are corner cubes, each defined by three rectangular isosceles triangular planes that are opposed perpendicularly to each other. Each corner cube is illustrated as an equilateral triangle on this top view. In the MCCA illustrated in FIG. 13(b), arranged are a number of corner cubes, each of which is illustrated as a regular hexagon, of which the center is defined by a bottom point, on this top view. And in the MCCA illustrated in FIG. 13(c), arranged are a number of corner cubes, each of which is illustrated as a rectangle, of which the center is defined by a bottom point, on this top view.

Also, according to the present invention, as long as the azimuthal directions of the ridge and valley portions of the corner cube array 10 define an angle of at least 7 degrees with respect to the source lines 34 and gate lines 35 when viewed perpendicularly to the front substrate, the corner cube array 10, the source lines 34 and the gate lines 35 do not have to be arranged as shown in FIG. 7(c).

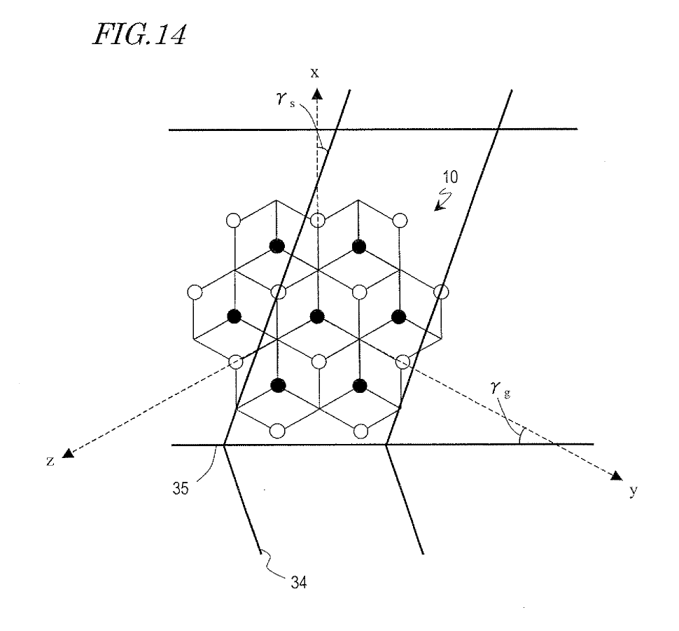

FIG. 14 is a plan view illustrating an alternative arrangement of the corner cube array 10, the source lines 34 and the gate lines 35. As shown in FIG. 14, the source lines 34 and the gate lines 35 do not have to cross each other at right angles but the source lines 34 and/or the gate lines 35 may extend in a zigzag pattern.

It should be noted that the present invention is applicable to not just a display device with the MCCA attached structure but also a display device in which the MCCA is arranged between the two substrates of the display panel (which will be referred to herein as an “MCCA built-in structure”). In such an MCCA built-in structure, the MCCA is arranged between the optical modulating layer and the rear substrate of the display panel (see Patent Document No. 3, for example). In such a structure, the MCCA is located closer to the viewer than the lines are. That is why the influence of scattering caused by those lines can be reduced significantly, but the light could still be scattered from the black matrix between the color filters. That is why by applying the present invention, the significant dark state leakage, which would be produced if the peak of the intensity of the light scattered from the black matrix and that of the intensity of the light scattered from the MCCA overlapped with each other, can be reduced. As a result, the black display performance can be improved.

### INDUSTRIAL APPLICABILITY

The present invention can be used in a reflective display device with a retroreflective layer to carry out a display operation at a high contrast ratio or with good visibility while minimizing the deterioration of the display performance such as dark state leakage or grayscale inversion, which would be caused by the light that has been incident on the retroreflective layer from a particular direction. Among other things, the present invention can be used particularly effectively in a reflective display device with a corner cube array in which a number of unit structures are arranged at a very small pitch and with high shape accuracy.

1. A reflective display device comprising:
an optical modulating layer that is switchable, on a pixel-by-pixel basis, between a first state and a second state that have mutually different optical properties in response to a voltage applied;
a front substrate and a rear substrate that sandwich the optical modulating layer between them; and
a retroreflective layer, which is arranged behind the optical modulating layer and which has a plurality of unit structures that are arranged two-dimensionally on a virtual plane,
the reflective liquid crystal display device conducting a display operation by using light that has been reflected back from the retroreflective layer,
wherein the device comprises:
gate lines, which are arranged on the rear substrate;
source lines, which are also arranged on the rear substrate so as to cross the gate lines as viewed from over the front substrate;
a switching element, which is also arranged on the rear substrate and which is activated in response to a signal that has been supplied to its associated one of the gate lines;
a pixel electrode, which is electrically connectible to its associated one of the source lines by way of the switching element; and
a counter electrode, which is arranged so as to face the pixel electrode,
wherein each said unit structure of the retroreflective layer has a recess defined by three planes that are opposed perpendicularly to each other, and
wherein as viewed from over the front substrate, each of the gate and source lines defines an angle of at least 7 degrees with respect to any of the azimuthal directions that are defined by projecting normals to the three planes of each said unit structure onto the virtual plane.

2. The reflective display device of claim 1, wherein as viewed from over the front substrate, the gate lines and the source lines cross each other substantially at right angles, the gate lines define the smallest angle of 7 to 15 degrees with respect to one of the azimuthal directions that are defined by projecting normals to the three planes of each said unit structure onto the virtual plane, and the source lines define the smallest angle of 7 to 15 degrees with respect to another one of the azimuthal directions that are defined by projecting normals to the three planes of each said unit structure onto the virtual plane.

3. The reflective display device of claim 1, wherein the unit structures are arranged on the retroreflective layer so as to face substantially the same direction.

4. The reflective display device of claim 3, wherein the three planes that are opposed perpendicularly to each other to form each said unit structure are all square.

5. The reflective display device of claim 1, wherein the retroreflective layer has a retroreflectivity of 66% to 100%.

6. The reflective display device of claim 1, wherein the unit structures are arranged on the retroreflective layer at a pitch of 3 μm to 1,000 μm.

7. The reflective display device of claim 1, wherein the retroreflective layer is arranged behind the rear substrate.

8. The reflective display device of claim 1, wherein the retroreflective layer is arranged between the optical modulating layer and the rear substrate.
